(19) United States
(12) Patent Application Publication
(10) Pub. No.: US 2023/0266593 A1
(43) Pub. Date: Aug. 24, 2023

(54) OPTICAL ELEMENT FOR COMPENSATION OF CHROMATIC ABERRATION

(71) Applicant: Lumus Ltd., Ness Ziona (IL)

(72) Inventor: Tsion EISENFELD, Ashkelon (IL)

(21) Appl. No.: 18/014,162

(22) PCT Filed: Oct. 26, 2021
(86) PCT No.: PCT/IL2021/051268

§ 371 Date: Jan. 2, 2023

Related U.S. Application Data
(60) Provisional application No. 63/105,367, filed on Oct. 26, 2020.

(51) Int. Cl. G02B 27/01; F21V 8/00

(52) U.S. Cl. CPC G02B 27/0172; G02B 6/0088; G02B 6/0023; G02B 2027/011; G02B 2027/0178

(57) ABSTRACT

An optical element (24) for compensating for chromatic aberration includes two wedge components (26, 28), each having different refractive indices and Abbe numbers. The two wedge components have the same wedge angle, and are bonded together oriented such that the outer surfaces are parallel to each other. The optical element (24) can be integrated in the optical path between an image projector (14) and a waveguide (12) in order to compensate for linear chromatic aberration introduced by a face-curve angle and/or pantoscopic tilt of the waveguide of a near-eye display.

### FIELD AND BACKGROUND OF THE INVENTION

The present invention relates to optical systems and, in particular, it concerns an optical element for compensation of linear chromatic aberration, and optical systems employing that element.

Generally, optical systems designed for a large spectral bandwidth, such as color displays, suffer from chromatic aberrations. Optical materials' refractive index depends on the incident ray wavelength. Typical glass dispersion exhibits lower refractive index for longer wavelengths. As a result, when light propagates through an optical system, rays with different wavelength will experience varying optical paths, generating chromatic aberration. This color aberration can be caused by a lens. The aberration behavior will then be radial in its spatial distribution. Chromatic aberrations can also be caused by non-parallelism of optical surfaces. The resulting color aberration will then be a linear variation along a spatial direction, referred to herein as “linear chromatic aberration”.

When the aberration is in a radial direction, an achromatic lens such as a doublet or a triplet lens can be designed to compensate for the aberration. The achromatic lens materials are chosen to be a flint or a crown glass (or plastic) with high and low Abbe number, allowing cancellation of the chromatic aberration. When linear, the chromatic aberration can be compensated by a compound prism with non-parallel flat surfaces. The prism apex angle as well as its material is optimized to correct the system wavelength dispersion. Furthermore, two or even three prisms with their own refractive index, Abbe number and apex angle can be conjugated for more accurate compensation. However, such prisms are bulky optical elements that occupy precious space in otherwise compact optical systems such as near eye displays. Such prisms also impose geometrical constraints on system design, since the prism deflects the optical axis.

In a color image display system in which each color of an RGB image is projected independently, offset due to system color aberration between the colors can also be corrected with a solution other than hardware, such as electronic compensation in the display matrix for projection systems, and similarly in a detector, for an imaging system. Compensation is achieved by electronically shifting the image generated by each color or wavelength such that they overlap in a final compensated image. The method has the benefit of flexibility. In theory, one can correct any kind of achromatic aberration, linear, radial or non-conventional distributions. It has the benefit of not requiring additional space in the optics. However, this requires special electronic design and higher power consumption. Additionally, electronic compensation cannot address point-spread within a single color due to the spectral width of each color of illumination, such as the output of color LEDs.

Particularly in augmented reality (AR) and virtual reality (VR) optical engines, form factor is paramount. Bulky optical elements for achromatic purposes are not suitable for such applications, and geometrical constraints introduced by compensating prisms may significantly complicated system architecture. Electronic compensation, on the other hand, has its own drawbacks as mentioned, and does not address chromatic dispersion and point spread resulting from the spectral bandwidth of each separate color.

### SUMMARY OF THE INVENTION

The present invention is an optical element for compensation of linear chromatic aberration, and optical systems employing such an element.

According to the teachings of an embodiment of the present invention there is provided, an optical element for compensating for chromatic aberration, the optical element comprising: (a) a first wedge component formed from a first transparent material having a first refractive index and a first Abbe number, the first wedge component having a first outer surface inclined at a wedge angle to a first bonding surface; and (b) a second wedge component formed from a second transparent material having a second refractive index differing from the first refractive index and a second

Abbe number differing from the first Abbe number, the second wedge component having a second outer surface inclined at the wedge angle to a second bonding surface, wherein the first bonding surface is bonded to the second bonding surface with the first and second wedge components oriented such that the first outer surface is parallel to the second outer surface.

According to a further feature of an embodiment of the present invention, the wedge angle is less than 15 degrees, and preferably less than 10 degrees.

According to a further feature of an embodiment of the present invention, the first wedge component and the second wedge component have edges defining a square or a rectangular shape, and wherein a direction of variation of a thickness of the first and second wedge components is at an oblique angle to the edges.

There is also provided according to the teachings of an embodiment of the present invention, a display system comprising: (a) an image projector generating a collimated projected image; (b) a light-guide optical element (LOE) having a pair of mutually-parallel major external surfaces, a coupling-in configuration for receiving the collimated projected image so as to propagate within the waveguide by internal reflection at the major external surfaces, and a coupling-out configuration for coupling the collimated projected image out from the waveguide towards a viewer; and (c) the aforementioned optical element interposed in a light path between the image projector and the LOE.

According to a further feature of an embodiment of the present invention, the first outer surface of the optical element is bonded to a surface of the image projector.

According to a further feature of an embodiment of the present invention, the second outer surface of the optical element is bonded to a surface of the coupling-in configuration.

According to a further feature of an embodiment of the present invention, the LOE is mounted on a support structure configured for supporting the LOE on the head of the viewer, the support structure supporting the LOE with a face-curve angle relative to a chief ray of the projected image coupled out towards the viewer, the optical element being configured to at least partially compensate for a chromatic aberration introduced by the face-curve angle.

According to a further feature of an embodiment of the present invention, the support structure supports the LOE with a pantoscopic angle relative to a chief ray of the projected image coupled out towards the viewer, the optical element being configured to at least partially compensate for a chromatic aberration introduced by the pantoscopic angle, as an alternative, or in addition, to at least partially compensating for chromatic aberration introduced by the face curve.

### BRIEF DESCRIPTION OF THE DRAWINGS

The invention is herein described, by way of example only, with reference to the accompanying drawings, wherein:

FIGS. 1A and 1B are schematic isometric views of an optical system implemented using a light-guide optical element (LOE), constructed and operative according to the teachings of the present invention, illustrating a top-down and a side-injection configuration, respectively;

FIGS. 2A and 2B are a schematic top view and side view, respectively, of the deployment of one of the LOEs of FIGS. 1A and 1B relative to the eye of a viewer, illustrating the linear chromatic aberration that is generated by the system in the absence of a compensation plate;

FIG. 3 is a schematic representation of an image projector from the optical system of FIGS. 1A and 1B shown with an attached compensation plate;

FIGS. 4A and 4B are schematic side views of the compensation plate, shown in an exploded state and an assembled state, respectively;

FIGS. 5A and 5B are views similar to FIGS. 2A and 2B, respectively, illustrating the effect of integration of the compensation plate of FIG. 4B between the image projector and the LOE;

FIGS. 6A and 6B are schematic isometric views of the compensation plate of FIG. 4B implemented with a circular and a rectangular outer shape, respectively; and

FIGS. 7A and 7B are schematic illustrations of a direction of linear chromatic aberration compensation in a case of an on-axis and an off-axis correction, respectively.

### DESCRIPTION OF THE PREFERRED EMBODIMENTS

The present invention is an optical element for compensation of linear chromatic aberration, and optical systems employing such an element.

The principles and operation of optical elements according to the present invention may be better understood with reference to the drawings and the accompanying description.

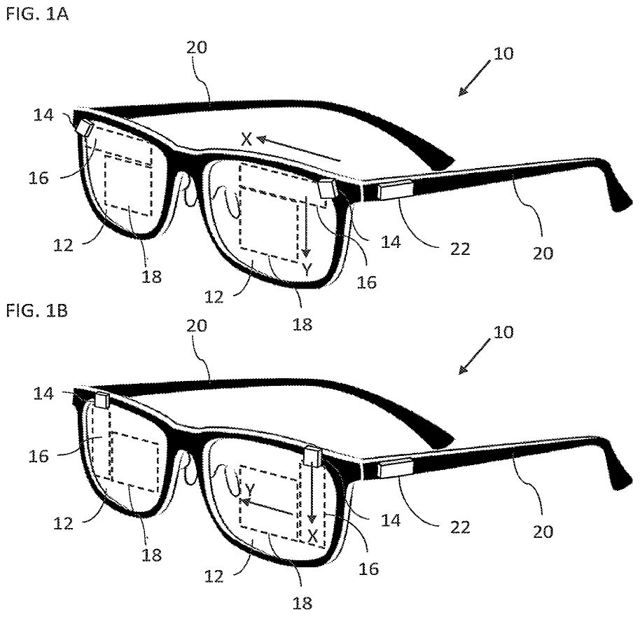

An exemplary implementation of a device in the form of a near-eye display, generally designated 10, employing a light-guide optical element (LOE) 12, is illustrated schematically in FIGS. 1A and 1B. This is a non-limiting example of a system in which context the compensation element of the present invention is used to advantage, as detailed below. The near-eye display 10 employs a compact image projector (or “POD”) 14 optically coupled so as to inject an image into LOE (interchangeably referred to as a “waveguide,” a “substrate” or a “slab”) 12 within which the image light is trapped in one dimension by internal reflection at a set of mutually-parallel planar external surfaces.

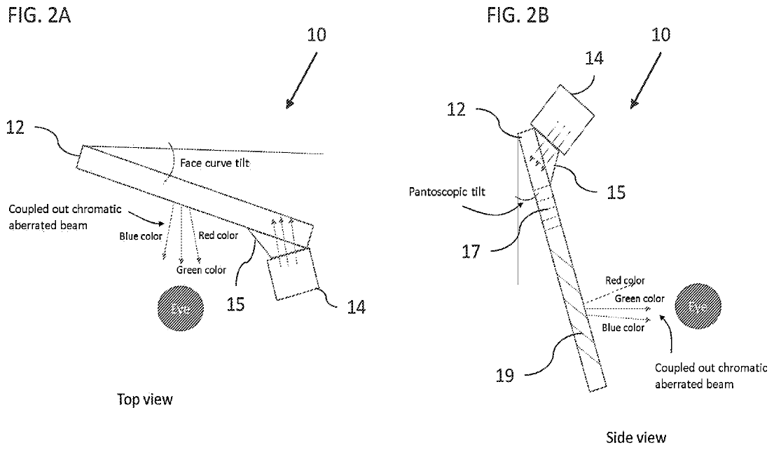

The LOE typically includes an arrangement for expanding the optical aperture of the injected image in one or two dimensions, and for coupling-out the image illumination towards the eye of the observer, typically based either on the use of internal partially-reflecting surfaces or on diffractive optical elements. In one non-limiting set of implementations further illustrated schematically in FIG. 2, the light injected into LOE 12 from image projector 14 impinges of a set of partially-reflecting surfaces (interchangeably referred to as “facets”) 17 that are parallel to each other, and inclined obliquely to the direction of propagation of the image light, with each successive facet deflecting a proportion of the image light into a deflected direction, also trapped/guided by internal reflection within the substrate. This first set of facets 17 are not illustrated individually in FIGS. 1A and 1B, but are located in a first region of the LOE designated 16 and are shown schematically in FIG. 2B. This partial reflection at successive facets achieves a first dimension of optical aperture expansion. In a first set of preferred but non-limiting examples of the present invention, the aforementioned set of facets 17 are orthogonal to the major external surfaces of the substrate. In this case, both the injected image and its conjugate undergoing internal reflection as it propagates within region 16 are deflected and become conjugate images propagating in a deflected direction. In an alternative set of preferred but non-limiting examples, the first set of partially-reflecting surfaces 17 are obliquely angled relative to the major external surfaces of the LOE. In the latter case, either the injected image or its conjugate forms the desired deflected image propagating within the LOE, while the other reflection may be minimized, for example, by employing angularly-selective coatings on the facets which render them relatively transparent to the range of incident angles presented by the image whose reflection is not needed.

The first set of partially-reflecting surfaces deflect the image illumination from a first direction of propagation trapped by total internal reflection (TIR) within the substrate to a second direction of propagation, also trapped by TIR within the substrate.

The deflected image illumination then passes into a second substrate region 18, which may be implemented as an adjacent distinct substrate or as a continuation of a single substrate, in which a coupling-out arrangement (either a further set of partially reflective facets 19 or a diffractive optical element) progressively couples out a proportion of the image illumination towards the eye of an observer located within a region defined as the eye-motion box (EMB), thereby achieving a second dimension of optical aperture expansion. The overall device may be implemented separately for each eye, and is preferably supported relative to the head of a user with the each LOE 12 facing a corresponding eye of the user. In one particularly preferred option as illustrated here, a support arrangement is implemented as an eye glasses frame with sides 20 for supporting the device relative to ears of the user. Other forms of support arrangement may also be used, including but not limited to, head bands, visors or devices suspended from helmets.

Reference is made herein in the drawings and claims to an X axis which extends horizontally (FIG. 1A) or vertically (FIG. 1B), in the general extensional direction of the first region of the LOE, and a Y axis which extends perpendicular thereto, i.e., vertically in FIG. 1A and horizontally in FIG. 1B.

In very approximate terms, the first LOE, or first region 16 of LOE 12, may be considered to achieve aperture expansion in the X direction while the second LOE, or second region 18 of LOE 12, achieves aperture expansion in the Y direction. It should be noted that the orientation as illustrated in FIG. 1A may be regarded as a “top-down” implementation, where the image illumination entering the main (second region) of the LOE enters from the top edge, whereas the orientation illustrated in FIG. 1B may be regarded as a “side-injection” implementation, where the axis referred to here as the Y axis is deployed horizontally. In the remaining drawings, the various features of certain embodiments of the present invention will be illustrated in the context of a “top-down” orientation, similar to FIG. 1A. However, it should be appreciated that all of those features are equally applicable to side-injection implementations, which also fall within the scope of the invention. In certain cases, other intermediate orientations are also applicable, and are included within the scope of the present invention except where explicitly excluded. Although illustrated herein in the context of an LOE which achieves two-dimensional expansion, it should be noted that the present invention is also applicable to devices in which an LOE performs only a single dimension of expansion.

The POD 14 employed with the devices of the present invention is preferably configured to generate a collimated image, i.e., in which the light of each image pixel is a parallel beam, collimated to infinity, with an angular direction corresponding to the pixel position. The image illumination thus spans a range of angles corresponding to an angular field of view in two dimensions.

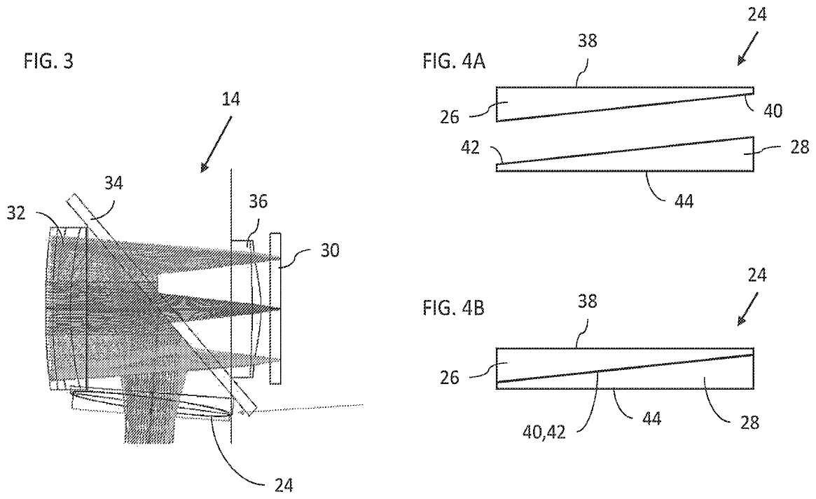

An example of image projector 14 is shown schematically in FIG. 3. Image projector 14 includes at least one light source (not shown), typically deployed to illuminate a spatial light modulator 30, such as a front-lit LCOS chip or a back-lit LCD panel. The spatial light modulator modulates the projected intensity of each pixel of the image, thereby generating an image. Another option is the use of a light-generating display, such as an OLED micro-display. Alternatively, the image projector may include a scanning arrangement, typically implemented using a fast-scanning mirror, which scans illumination from a laser light source across an image plane of the projector while the intensity of the beam is varied synchronously with the motion on a pixel-by-pixel basis, thereby projecting a desired intensity for each pixel. In all of these cases, collimating optics 32 are provided to generate an output projected image which is collimated to infinity. A field lens 36 may be provided adjacent to the image generator. Some or all of the above components are typically arranged on surfaces of one or more polarizing beam-splitter (PBS) cube or other prism arrangement, including PBS 34, as is well known in the art.

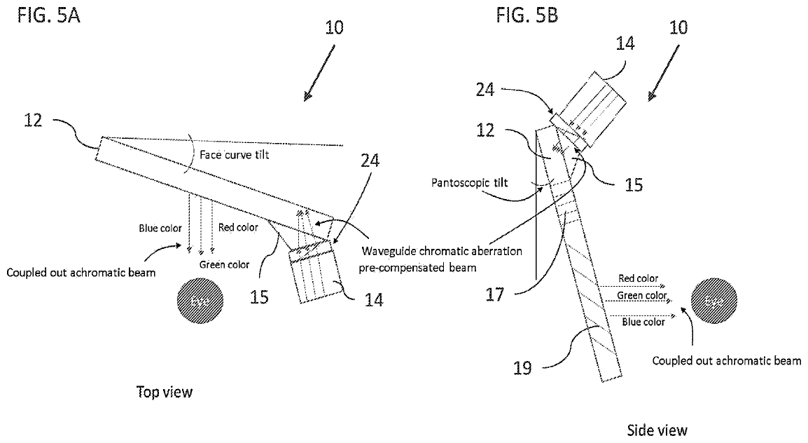

Optical coupling of image projector 14 to LOE 12 may be achieved by any suitable optical coupling, such as for example via a coupling prism with an obliquely angled input surface, or via a reflective coupling arrangement, via a side edge and/or one of the major external surfaces of the LOE. Details of the coupling-in configuration are not critical to the invention, and are shown here in FIGS. 2A-2B and 5A-5B schematically as a non-limiting example of a wedge prism 15 applied to one of the major external surfaces of the LOE.

It will be appreciated that the near-eye display 10 includes various additional components, typically including a controller 22 (FIG. 1A-1B) for actuating the image projector 14, typically employing electrical power from a small onboard battery (not shown) or some other suitable power source. It will be appreciated that controller 22 includes all necessary electronic components such as at least one processor or processing circuitry to drive the image projector, all as is known in the art.

For aesthetic reasons, the waveguide of an AR near-eye display has non-normal orientation relative to the user's eye. It is desirable to design AR glasses that are as similar as possible to conventional eye glasses. As a consequence, the out-coupled projected image optical axis is not normal to the waveguide surface. This generates linear chromatic aberrations along the projected image. The colors of the image will appear shifted. The user will see a shifted image duplicated in different colors. Furthermore, linear chromatic aberration will increase the PSF of the different image fields (as explained previously) such that even if electronically corrected, the image MTF will still be affected.

These two sources of linear chromatic aberration resulting from a typical deployment of a near-eye display on the face of a user are illustrated schematically in FIGS. 2A and 2B. Firstly, as shown in the top view of FIG. 2A, fitting of a near-eye display to the curvature of the human face typically requires the LOE 12 to be arranged at a “face-curve tilt” relative to the primary viewing direction (center field) of the projected image. This results in a projected image exiting from the LOE surface at an oblique (non-perpendicular) angle, thereby giving rise to chromatic dispersion at the LOE-air boundary.

Additionally, as illustrated in the side view of FIG. 2B, a near-eye display is typically deployed with a pantoscopic tilt, such that the lower edge of the LOE is closer to the face than the upper edge. This too results in an oblique (non-perpendicular) exit angle of the center field of the projected image exiting from the LOE surface, thereby giving rise to chromatic dispersion at the LOE-air boundary. These two effects are often combined, giving rise to an overall linear chromatic aberration which varies both horizontally and vertically across the field of view of the image.

In order to at least partially compensate for these linear chromatic aberrations, according to an aspect of the present invention, a compensation element is preferably interposed between the image projector and the LOE so that the collimated beams making up the output image of the image projector propagate through the compensating plate before being coupled into the waveguide. Specific chromatic aberrations are thus intentionally injected into the collimated beam by the compensation plate to cancel the coupling out chromatic aberration generated on exit from the waveguide. The out coupled collimated beam will then reach the user's eye with reduced chromatic aberration.

Two examples of an implementation of an optical element (“compensation plate”) 24 for compensating for chromatic aberration according to the present invention are illustrated in FIGS. 4A and 4B. The optical element includes a first wedge component 26 formed from a first transparent material having a first refractive index and a first Abbe number. First wedge component 26 has a first outer surface 38 inclined at a wedge angle to a first bonding surface 40. The compensation plate also includes a second wedge component 28 formed from a second transparent material having a second refractive index differing from the first refractive index and a second Abbe number differing from the first Abbe number. Second wedge component 28 has a second outer surface 44 inclined at the same wedge angle to a second bonding surface 42. For clarity of presentation, the two wedge components are shown separated in FIG. 4A, but are combined as illustrated in FIG. 4B with first bonding surface 40 bonded to second bonding surface 42 with first and second wedge components 26 and 28 oriented with oppositely directed wedge angles such that the first outer surface 38 is parallel to the second outer surface 44.

It will immediately be apparent that the form factor of the compensation plate 24 is highly advantageous in that it is a relatively thin parallel-faced element which can readily be interposed between other components of an optical system without changing the overall geometry and without significantly increasing the bulk of the optical system. By way of example, the wedge angle employed for the first and second wedge components is preferably less than 15 degrees, and most preferably less than about 10 degrees. As a result, for an exemplary optical aperture of about 8 millimeters, the overall thickness of optical element 24 is preferably no more than about 1.5 millimeters, and in some cases, about 1 millimeter or less. Nevertheless, it has been found that, by suitable choice of the optical properties of the materials for the first and second wedge components, it is possible to achieve a high degree of compensation for linear chromatic aberrations such as those described above.

In order to achieve highly effective compensation for chromatic aberration in a compact implementation of optical element 24, it is preferable to have a significant differential in Abbe number between the materials employed for the first and second wedge components, and most preferably a difference in Abbe number (ΔAbbe) of at least 20. In order to limit the extent of deflection of the chief ray passing through the optical element, it is preferable that the difference in refractive index (ΔRI) between the two materials be relatively small, and most preferably no more than about 0.3.

Depending on the context in which the compensation plate is used, it may be desirable to provide antireflective coatings on some or all of the surfaces. Where the difference in refractive indices between the materials of the two wedge components is small, antireflective coatings are typically not needed. Where the plate is to be used adjacent to another optical element with a significantly different refractive index, antireflective coatings may enhance system performance significantly.

The precision of parallelism between the outer surfaces of compensation plate 24 is typically not critical, and most of the advantages of the implementation may be achieved even if the outer surfaces have a slight angular offset of a degree or more, so long as they still approximate to parallel surfaces in the context of the overall device geometry. In certain cases, it may be preferred that the external surfaces are parallel to a tolerance of a fraction of a degree (e.g., to within about 20 minutes of arc, and in some cases, in the order of 10 minutes of arc or below).

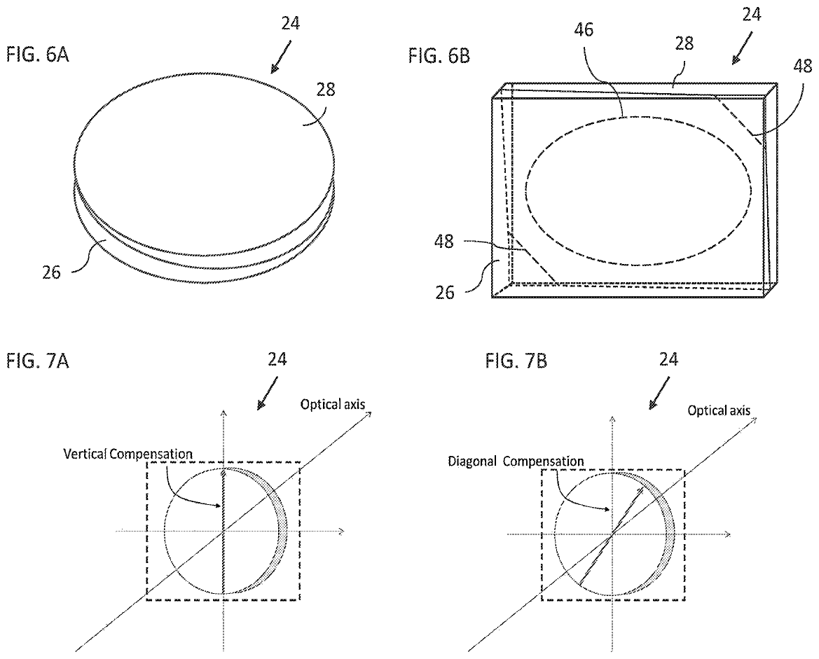

As illustrated in FIGS. 6A and 6B, the outer shape of the compensation plate 24 may be any desired shape, including but not limited to a round shape as in FIG. 6A or a rectangular (including square) shape as in FIG. 6B. Provision of straight edges defining a square or rectangular shape may facilitate correct alignment of the compensation plate during assembly of a system. In certain cases, the area of the plate may be larger than the optical aperture over which the compensation is required, as illustrated schematically, for example, by a dashed ellipse 46 in FIG. 6B. In this case, the surfaces of wedge components 26 and 28 lying outside the region of the optical aperture 46, such as the corner regions designated by dashed lines 48, do not need to be implemented as a continuation of the wedge geometry, and do not necessarily need to be finished to optical surface quality.

The direction of variation of thickness of the wedge components is chosen to provide correction for (or more accurately, a preemptive opposite distortion which is then reversed by) the linear chromatic aberration that is inherent to the system design. For on-axis chromatic aberration, such as generated by face-curve tilt alone or pantoscopic tilt alone, the direction of wedge thickness variation may be on one of the axes of the construction, such as illustrated in FIG. 7A. Where correction is required for both face-curve tilt and pantoscopic tilt, or where other aspects of the system design dictate a rotated orientation for the image projector relative to the waveguide axes, an appropriately chosen direction of variation of the thickness of the first and second wedge components is typically at an oblique angle to the edges defining the square or rectangular shape, or relative to the primary axes of the image projector in the case of a round compensation plate.

FIGS. 5A and 5B illustrate an exemplary deployment of compensation plate 24 as part of a display system 10, where the compensation plate 24 is interposed in a light path between the image projector 14 and LOE 12. According to one particularly preferred implementation, as also illustrated in FIG. 3, first outer surface 38 of compensation plate 24 is bonded to a surface of the image projector 14. This essentially turns the compensation plate into a part of the projector assembly, rendering assembly of the device particularly convenient and simple.

In certain implementations, second outer surface 44 of the optical element (compensation plate) is bonded to a surface of coupling-in configuration 15. This results in the structure as illustrated in FIGS. 5A and 5B.

The display system 10 as illustrated in FIGS. 5A and 5B can thus at least partially compensate for a chromatic aberration introduced by the face-curve angle or by a pantoscopic tilt angle, or a combination of both.

In order to correct the chromatic aberration generated by more than one waveguide inclination, for example a pantoscopic waveguide tilt in addition to a face curve waveguide tilt, the compensation plate should be orientated diagonally relative to the optical axis.

Although illustrated herein in the context of a LOE (waveguide) with internal partially-reflecting surfaces (facets) for optical aperture expansion and coupling out, the invention may equally be implemented to advantage with waveguide-based displays employing diffractive optical elements for coupling-in, aperture expansion and/or coupling out of the image, or any combination of reflective and diffractive technology, or any other image projection technology.

Additionally, although illustrated in the context of a near-eye display, the invention can also be used to advantage with a wide range of other display systems, for example, in an automotive display for a vehicle windshield or window, where the deployment dictates a waveguide orientation that is non-perpendicular to the primary (center field) image projection direction.

Furthermore, the optical element 24 described herein is not limited to applications in display devices, and may be used to advantage in a wide range of other optical systems, wherever linear chromatic aberration is to be corrected. When in displays or in other optical systems, the ability to compensate for linear chromatic aberration by introducing a compact, parallel-faced component into the optical path provides design flexibility to optimize other design parameters, such as the geometry of image projection optics relative to an eyeglass frame, and the desired face curve and pantoscopic tilt orientations, without concern for the linear chromatic aberration introduced by the design, and then to correct for that aberration with minimal impact on the design geometry and dimensions.

It will be appreciated that the above descriptions are intended only to serve as examples, and that many other embodiments are possible within the scope of the present invention as defined in the appended claims.

What is claimed is:

1. An optical element for compensating for chromatic aberration, the optical element comprising:
(a) a first wedge component formed from a first transparent material having a first refractive index and a first Abbe number, said first wedge component having a first outer surface inclined at a wedge angle to a first bonding surface; and
(b) a second wedge component formed from a second transparent material having a second refractive index differing from said first refractive index and a second Abbe number differing from said first Abbe number, said second wedge component having a second outer surface inclined at said wedge angle to a second bonding surface,
wherein said first bonding surface is bonded to said second bonding surface with said first and second wedge components oriented such that said first outer surface is parallel to said second outer surface.

2. The optical element of claim 1, wherein said wedge angle is less than 15 degrees.

3. The optical element of claim 1, wherein said wedge angle is less than 10 degrees.

4. The optical element of claim 1, wherein said first wedge component and said second wedge component have edges defining a square or a rectangular shape, and wherein a direction of variation of a thickness of said first and second wedge components is at an oblique angle to said edges.

5. A display system comprising:
(a) an image projector generating a collimated projected image;
(b) a light-guide optical element (LOE) having a pair of mutually-parallel major external surfaces, a coupling-in configuration for receiving the collimated projected image so as to propagate within the waveguide by internal reflection at said major external surfaces, and a coupling-out configuration for coupling the collimated projected image out from the waveguide towards a viewer; and
(c) the optical element of any preceding claim interposed in a light path between said image projector and said LOE.

6. The display system of claim 5, wherein said first outer surface of said optical element is bonded to a surface of said image projector.

7. The display system of claim 6, wherein said second outer surface of said optical element is bonded to a surface of said coupling-in configuration.

8. The display system of claim 5, wherein said LOE is mounted on a support structure configured for supporting said LOE on the head of the viewer, said support structure supporting said LOE with a face-curve angle relative to a chief ray of the projected image coupled out towards the viewer, said optical element being configured to at least partially compensate for a chromatic aberration introduced by said face-curve angle.

9. The display system of claim 8, wherein said support structure supports said LOE with a pantoscopic angle relative to a chief ray of the projected image coupled out towards the viewer, said optical element being configured to at least partially compensate for a chromatic aberration introduced by said face curve and by said pantoscopic angle.

10. The display system of claim 5, wherein said LOE is mounted on a support structure configured for supporting said LOE on the head of the viewer, said support structure supporting said LOE with a pantoscopic angle relative to a chief ray of the projected image coupled out towards the viewer, said optical element being configured to at least partially compensate for a chromatic aberration introduced by said pantoscopic angle.
